(19) United States
(12) Patent Application Publication
(10) Pub. No.: US 2006/0118538 A1
(43) Pub. Date: Jun. 8, 2006

(54) Bezel for heated handle

(75) Inventors: Tom Jones, Windsor (CA); Gabriella Almasi, Windsor (CA)

Correspondence Address: DOBRUSIN & THENNISCH PC, 29 W LAWRENCE ST, SUITE 210, PONTIAC, MI, 48326, US

(73) Assignee: W.E.T. Automotive Group AG

(21) Appl. No.: 11/295,875

(22) Filed: Dec. 7, 2005

Related U.S. Application Data
(60) Provisional application No. 60/634,220, filed on Dec. 8, 2004.

(51) Int. Cl. B60L 1/02

(52) U.S. Cl. 219/204

(57) ABSTRACT

The present invention relates to a bezel for a heated handle where the bezel includes a heating element. The bezel heating element preferably electrically connects to a heating element on handle so as to eliminate the need for a separate power source of the bezel heating element. The invention also relates to heated handle incorporating the heated bezel, as well as method for heating handles.

### CLAIM OF PRIORITY

This application claims the benefit of U.S. patent application Ser. No. 60/634.220, filed on Dec. 8, 2004, hereby incorporated by reference.

### FIELD OF THE INVENTION

The present invention relates generally to heated handles and more particularly to bezels for heated steering wheels.

### BACKGROUND OF THE INVENTION

For many years, industry has been concerned with designing improved comfort for handles used in transportation vehicles or elsewhere and has been particularly concerned with designing improved heaters for steering wheels for automotive vehicles. As examples, U.S. Pat. Nos. 6,172,342, and 6,093,908 are directed toward advancements in designs for steering wheels of automotive vehicles.

Handles also often include decorative elements such as bezels, which are inserts on the handle that typically are made of plastic, wood, wood veneer, metal or other materials. Bezels often serve to breakup the covering of the handle. Incorporating bezels into heated handles has been problematic because they are not readily heated by the heating element in the handle, thus causing an uncomfortable temperature difference between the portions of the handle, especially in colder climates.

The present invention provides an improved bezel for a heated handle, which may be suitable for various transportation vehicles or other uses, but which has found particular utility as a steering wheel heater for an automotive vehicle.

### SUMMARY OF THE INVENTION

The present invention relates to a bezel for a heated handle where the bezel includes a heating element. The bezel heating element preferably electrically connects to a heating element on handle so as to eliminate the need for a separate power source of the bezel heating element. The invention also relates to heated handle incorporating the heated bezel, as well as method for heating handles.

### BRIEF DESCRIPTION OF THE DRAWINGS

The features and inventive aspects of the present invention will become more apparent upon reading the following detailed description, claims and drawings, of which the following is a brief description:

FIG. 1 shows a perspective view of a bezel for use with a steering wheel;

FIG. 2 shows the underside or a B-side view of a heated handle in accordance with one embodiment of the present invention;

FIG. 3 shows a cross-section a bezel along line 3-3; and

FIG. 4 shows the placement the bezel on a steering wheel.

### DETAILED DESCRIPTION OF THE INVENTION

The present invention comprises a bezel for inclusion in a heated handle that has its own heating element.

The bezel may be employed in a variety of handles for transportation vehicles including, interior and exterior door handles, gear shift handles, arm rests, steering wheels, cargo door handles, or the like. Without limitation, the handles may suitable be used in busses, automobiles, boats, trains, tractors, motorcycles, airplanes, or other transportation vehicles. It is also contemplated that the heated handle may be employed in a variety of other applications such as within buildings, outdoors or the like. As other examples, the heated handle may be configured as a stair rail or other railing, a door handle, a window handle or the like. The preferred heated handle utilizing the instant bezel is configured as a heated steering wheel for an automotive vehicle.

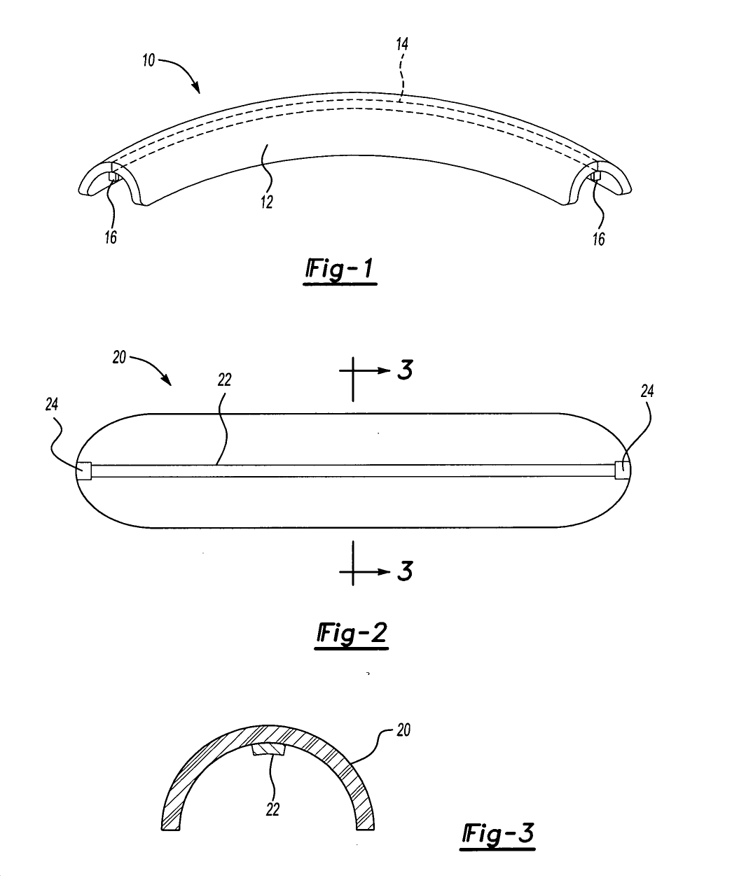

As seen in FIG. 1, the bezel 10 includes a thermally conductive substrate 12, a heating element 14 (shown in phantom), and electrical contacts 16.

The substrate for the bezel is any thermally conductive material that may be shaped to form a bezel. The material need only be minimally thermally conductive so as to permit some heat generated by the heating element to reach the surface of the handle. Preferably, the material is thermally conductive enough to permit the bezel to reach the temperature of the remainder of the heated handle.

The material of the bezel should provide a rigid or semi-rigid structure to the bezel such that the material is not malleable. While flexing of the material is acceptable, the material should be dimensionally stable under the operating conditions where the handle is used (e.g. in an automobile).

Substrates can be formed of metals or metal alloys, plastics (e.g., thermoplastics, thermosets, or combinations thereof), elastomers (e.g. natural or synthetic rubber, or the like), ceramics, woods (e.g., oak, walnut, maple, pine, cherry, ash, teak, mahogany, or combinations thereof), glasses (e.g., Pyrex or the like), or combinations thereof.

Preferably, the substrate is formed of a thermoplastic or a thermoset. Thermoplastics and thermosets can be fortified with one ore more fiber materials (e.g., glass, polymers, ceramics, metals, alloys, or the like). More preferably, the substrate is formed of an unfortified thermoplastic (i.e., a thermoplastic substantially free of fiber materials) that is moldable and having a melt temperature greater than 110° C. Most preferably, the substrate is formed of an unfortified thermoplastic that is moldable and having a with a melt temperature greater than 150° C.

Additionally, the bezel preferably includes an A-side that is aesthetically acceptable to the vehicle operator. In this way, the substrate may comprise a combination of materials such that the A-side differs from the rest of the substrate. In one embodiment, the A-side of the bezel comprises a wood veneer or wood grain simulated in plastic along with a protective top coat (e.g. polyurethane), while the remainder of the bezel need not have a particular aesthetic appearance.

The overall shape of the bezel will generally be complimentary to the shape of the handle in which it is being utilized. For example, on steering wheels, the bezel will typically be arcuate to match a portion of the rim of the steering wheel, while on gear shifters, the bezel may a disk and on door handles the bezel may be linear. However, it is also contemplated that the bezel may also occupy substantially the entire visible surface of the handle. For example, on a steering wheel, the bezel may be complementary to the entire steering wheel rim (e.g. a circle). The cross-sectional shape of the bezel will also be complementary to the shape of the handle on which it is utilized. For example, on a steering wheel, a crescent moon shape may be used to match the round cross section of the steering wheel rim.

The bezel also comprises at least one, and preferably only one, heating element. The heating element is incorporated into the substrate, meaning the that heating element is near enough to the substrate that heat generated by the heating element warms the bezel even though the heating element may be separated from the substrate by air or other materials. In addition, an incorporated heating element means that the heating element is adjacent to the substrate or substantially surrounded by the substrate such that the substrate conducts the heat generated by the heating element.

Any heating element type may be used, but resistance heating elements are preferred because of the cost effectiveness and ease of use. Resistant heating wires having metal or carbon fiber strands as conductors are preferred, with a single strand or bundle of strands used as the heating element being most preferred. The strands of wire may be braided or otherwise wound around a non-conductive core. The strands may be cladded with a protective layer or otherwise, as well as being individually insulated with a lacquer material, an enamel material or other suitable insulating material.

Other formats for resistance heating elements may also be used such as foil type heating elements. Foil type heating elements are substantially planar in shape with a length and width that are greater than its thickness. Such a format means that the heating element does not occupy significant space and can be incorporated into bezels and handles where space is a concern. Mesh-type heating elements may also be used and may be provide similar benefits as foil type heating elements.

In one embodiment, the bezel heating element includes a bundle of wires (e.g., about 3 to about 9 strands, more preferably about 5 to about 7 strands). Preferably the strands each have a diameter between about 0.004 mm or less and about 0.02 mm or greater, more preferably between about 0.007 mm and about 0.011 mm and still more preferably between about 0.008 mm and about 0.009 mm.

Suitable materials for the heating element include conductive metals (e.g. copper, nickel, copper cladded with nickel, etc.), conductive polymers (e.g. PTC polymers), polymers with conductive dispersions, carbon fibers or the like and combinations thereof.

Any particular resistance for the heating element may be used with the thickness and mass of the bezel substrate, the area of the bezel, and the ultimate desired temperature of the bezel being factors that may be considered in selecting the resistance.

Preferably, the bezel heating element is the same type as the handle heating element to ease installation and operation of the heating elements, although different types may be used (e.g. resistance wire and PTC).

In a preferred embodiment, the heating element is selected to have a heat output that will warm the bezel to a comfortable level for the occupant. In a preferred embodiment, the bezel and the remainder of the handle will provide heating such that an occupant will not perceive a distinction in temperature between the bezel and the remainder of the handle. Thus, a bezel may include a stronger heating element than in the remainder of the handle if the bezel substrate is less thermally conductive than the handle covering. Of course, the opposite is also true.

The heating element of the bezel may be attached to or incorporated into the substrate of the bezel, typically such that the heating element is out of sight from the vehicle operator. However, this is not necessarily the case, as the heating element may attached or incorporate in a way that is aesthetically acceptable to the vehicle operator (e.g. as a visible wire or pattern on the A-side of the bezel).

In one embodiment, the heating element is attached to the bezel away from the A-side through the use of adhesive tape or glue, as is seen in FIGS. 2-3. In this embodiment, a relatively straight bezel 20 has a heating element 22 glued to the underside of the bezel with a pair of contacts 24 located at either end of the bezel to connect the heating element to a power source or contacts on another heating element.

In another embodiment, the substrate of the bezel is molded around the heating element so that the substrate substantially surrounds the heating element. Alternately, the heating element may be sandwiched between two or more layers of materials that make up the substrate. In one embodiment, the heating element is held within a tunnel in the substrate, where the tunnel is molded or drilled into the substrate. In this embodiment, the heating element (e.g. a wire) may be threaded through the tunnel so as to be incorporated into the substrate. In another embodiment, the substrate of the bezel includes integrated or partially integrated attachment mechanisms for the heating element. For example, the heating element may be snapped into integrated fingers or a trench on the substrate to hold the heating element in place. Further, a snap fit clamp or crimp may be used to attach the heating element to the substrate. The heating element may also be printed or sprayed onto the substrate such as with a PTC heating element.

In yet another embodiment, a meltable covering is included on the bezel heating element. See, e.g. U.S. Patent Publication 2004-0094534, hereby incorporated by reference. The covering may be used to attach or assist in attaching the heating element to the bezel and/or the bezel to the handle. For example, when the bezel heating element is energized, the covering melts and upon cooling hardens so as to connect the bezel heating element to the bezel and the bezel to the handle. Of course, the attachment mechanisms may be used in combination with each other.

The layout of the heating element in or on the bezel is not critical; preferred layouts provide a heat output to provide the bezel with a consistent temperature across the bezel. A heating element that traverses from one end to the other end of the bezel in a substantially straight line is preferred as requiring the least amount of materials. Nonetheless, other layouts may also be utilized including a down-and-back layout, zig-zagging layouts, sinusoidal layouts and combinations thereof.

In addition to the substrate and the heating element, the bezel also includes a set of electrical contacts. The contacts provide a means to electrically power the heating element from a power source. While soldering may provide the strongest connection between the bezel heating element and the contacts, techniques not requiring heat (such as adhesive, crimping or other mechanical fasteners) are preferred to make the connection between the heating element and the contacts.

In one preferable embodiment, the electrical contacts on the bezel and the handle also act as mechanical fasteners to connect the bezel to the handle (e.g. metal snaps). Such a combination of purposes would provide secure electrical and physical connections between the bezel and the heated handle while easing the complexity of the installation of the bezel on the heated handle.

In one preferred embodiment, the bezel heating element draws power from the same power source as the handle heating element. More preferably, the bezel heating element is connected to the handle heating element so the bezel heating element draws power through the handle heating element. Such a system simplifies the system needed to heat the bezel because separate leads need not be run from the bezel heating element to the power source. Rather reciprocal contacts on the handle heating element may be used to provide power to the bezel heating element. This is particularly useful because heated handles typically have their power source located remotely from the handle. Of course, the bezel heating element may draw power directly from a power source (whether it is the power source for the handle heating element or a separate power source).

Assembly of the bezel comprises combining the heating element and contacts with the substrate of the bezel. Examples of suitable techniques include molding the substrate around the heating element while leaving the contacts exposed or exposing the contacts later. Layering of substrate materials around the heating element is another suitable technique, as is threading the heating element through a tunnel in the substrate. In another embodiment, bezel may be manufactured by a co-molding process wherein the substrate is formed via injection molding, blow molding, or any other process(es) that creates a substrate with a tunnel running substantially the entire length of the substrate into which heating element material is injected and cured. In this process, the molded substrate functions as a mold for the material of the heating element.

Further, attaching the heating element and contacts to substrate using adhesive or the like is also preferred. Any aesthetic appearance of the bezel may be created or applied before, after or during the combining of the substrate with the heating elements and the contacts.

Typically, the bezel will be monolithic after assembly as a single piece after assembly is easier to handle and install on the heated handle than multiple pieces, however, this is not necessarily the case.

Assembly of the bezel and the heated handle involves electrically and physically connecting the bezel to the handle in an essentially permanent for the operable life of the heated handle. At a minimum, electrical contacts on the handle need to be available to connect to the bezel. This may be accomplished by cutting through any covering material of the handle. Physical attachment may then be accomplished through an adhesive, mechanical fasteners or the like to the covering material or through soldering or mechanical fasteners to the exposed electrical contacts.

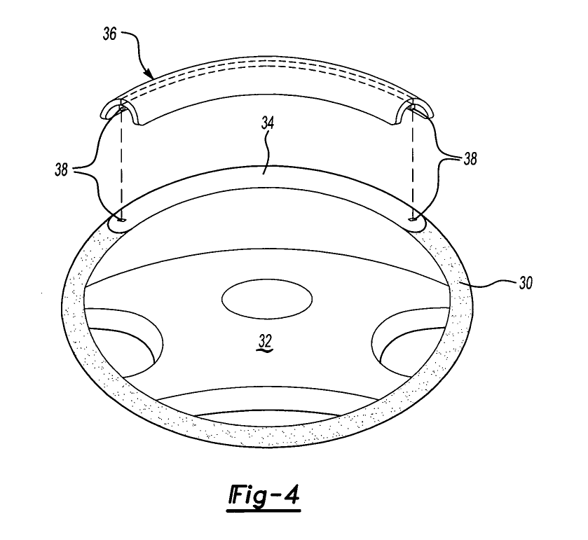

As generally seen in FIG. 4, a more aesthetically pleasing effect may be achieved by attaching the bezel such that the A-side of the bezel is approximately flush with the surrounding covering of the handle. To achieve this, a portion of a covering 30 of the handle 32 may be removed to create a cutout 34 in the covering into which the bezel 36 is placed. Removal of the covering is typically performed after the covering has been placed on the handle. As placement of the covering may involve significant pulling on the covering, any cutouts in the covering would distort under the tension of installation. Consequently, creating the cutouts after installation of the covering is preferred. Multiple cutouts may be used for bezels that cover relatively large areas of the handle or where areas of covering between the cutouts help maintain the positioning of the covering. This is particularly true for bezels that cover an entire surface of the handle (e.g. the front surface of a steering wheel rim).

Further, in addition to preparing the handle for installation of the bezel, the cutouts may also expose portions of the handle heating element, electrical contacts on the handle heating element and/or physical attachment points on the handle. The cutouts are typically created manually to avoid damage to the handle heating element underlying the covering. Alternately, the handle heating element is specifically designed to withstand any damage that may occur during the creation of the cutout for the bezel.

The bezel may be physically attached to the handle using a variety of suitable techniques including two sided tape, adhesives, hook-and-loop fasteners, mechanical fasteners (e.g. screws, brads or snap fit fasteners), and combinations thereof. Snap fit fasteners are preferred because their use eases the complexity of installation compared to tapes or adhesives.

Electrical connection of the bezel to the heating element may involve the use of soldering, conductive adhesives, crimping, other mechanical fasteners or merely placing the contacts adjacent to one another.

Preferred attachment mechanisms include those that have the dual purpose of attaching the bezel to the handle as well as making any needed electrical connections between the bezel and the handle, as is shown in FIG. 4 at reference numerals 38.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

It will be further appreciated that functions or structures of a plurality of components or steps may be combined into a single component or step, or the functions or structures of one step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A bezel for a heated handle, comprising:
a thermally conductive substrate;
a heating element incorporated into the thermally conductive substrate; and
a pair of electrical contacts attached to the heating element.

2. The bezel of claim 1 wherein the heating element comprises a resistive heating element.

3. The bezel of claim 2 wherein the heating element is adjacent to the substrate.

4. The bezel of claim 3 wherein the resistive heating element is adhesively attached to the substrate.

5. The bezel of claim 2 wherein the heating element is substantially surrounded by the substrate.

6. The bezel of claim 5 wherein the substrate is molded about the heating element.

7. The bezel of claim 6 further comprising one or more fasteners for attaching the bezel to a handle.

8. The bezel of claim 7 wherein the fasteners also serve as the electrical contacts.

9. A handle, comprising:
a handle comprising a handle heating element having at least a pair of main electrical contacts;
a bezel comprising a secondary heating element and at least a pair of secondary electrical contacts,
wherein the bezel is attached to the handle to align the pair of main electrical contacts with the pair of secondary electrical contacts.

10. The handle of claim 9 further comprising a power source connected to the handle heating element and the bezel heating element.

11. The handle of claim 10 wherein the power source supplied power to the bezel heating element through the handle heating element.

12. The handle of claim 11 wherein the bezel is located in a cutout of a covering of the main handle portion.

13. The handle of claim 12 wherein the bezel is attached to the handle via adhesive, mechanical fasteners and combinations thereof.

14. The handle of claim 13 wherein the bezel heating element comprises a resistive heating element.

15. The handle of claim 14 wherein the bezel heating element is adhesively attached to a bezel substrate.

16. The handle of claim 14 wherein a bezel substrate substantially surrounds the bezel heating element.

17. The handle of claim 14 wherein the handle comprises a steering wheel, a shift handle, an exterior door handle, an interior door handle, a knee bolster, an armrest and combinations thereof.

18. The handle of claim 9 wherein the heating element comprises a PTC heating element.

19. A method of forming a heated handle, comprising:
connecting a pair of electrical contacts on a bezel heating element to a pair of electrical contacts on a handle heating element.

20. The method of claim 19 further comprising incorporating the bezel heating element to a bezel substrate to form a heated bezel.

21. The method of claim 20 further comprising attaching the heated bezel to the handle with adhesive, mechanical fasteners, and combinations thereof.
